(19) United States
(12) Patent Application Publication
(10) Pub. No.: US 2012/0153192 A1
(43) Pub. Date: Jun. 21, 2012

(54) MEDIA SENSING SYSTEM FOR A PRINTER

(76) Inventors: Roger Bastardas Puigoriol, Sant Just Desvern (ES); Laura Portela Mata, Barbera del Valles (ES)

(21) Appl. No.: 12/972,900

(22) Filed: Dec. 20, 2010

(51) Int. Cl. G01N 21/86

(52) U.S. Cl. 250/559.4

(57) ABSTRACT

In one example, a media sensing system for a printer includes: a light source; a light sensor for receiving light from the light source; and a portable filter removably supported between the light source and the light sensor. The filter is configured to reduce the amount of light received by the light sensor from the light source. In another example, a method for aligning a media sensing system includes: a light source emitting light toward a light sensor; filtering the emitted light before it reaches the light sensor; the sensor sensing filtered light; and, if a desired amount of filtered light is not sensed by the sensor, then adjusting the position of the light source and/or the light sensor until the desired amount of filtered light is sensed by the sensor.

### BACKGROUND

Large format inkjet printers, typically used in commercial settings, may print media widths of 160 centimeters or more. The print media moves under a printer carriage that carries a series of ink pens back and forth across the media to deposit ink at the correct locations on the media to produce the desired image. Many large format printers use heaters to dry the ink after it is applied to the media. Heaters drying latex inks, for example, may generate temperatures up to 700° C. Furthermore, the heaters are typically placed close to the media for rapid drying. A media jam in the printer may bring the media too close to a heater or even into contact with a heater, resulting in damage to the media or a fire. Some large format printers use a media sensing system to sense when the media is too close to a heater. Such media sensing systems are sometimes commonly referred to as media “crash” sensors. If the media comes too close to the heater, the crash sensor shuts off the heater to help prevent damage to the media or a fire. In one type of crash sensor used in large format printers, a beam of light is projected across the width of the media to a reflector that reflects light back across the media to a light sensor located in the same unit as the light source. If the media comes too close to a heater, the media will trigger the sensor by blocking some or all of light that reaches the light sensor. Since the distance between the light source/sensor unit and the reflector may be 200 centimeters or more, it is important that the light source and light sensor be properly aligned to the reflector.

### BRIEF DESCRIPTION OF THE DRAWINGS

FIG. 1 is a block diagram illustrating an inkjet printer that includes a media sensing system according to one example of the invention.

FIG. 2 is a perspective view illustrating a media sensing system according to one example of the invention.

FIGS. 3A-3E show misalignment of a light beam hitting a reflector in a media sensing system such as that shown in FIG. 2 to illustrate the difficulty compensating for excess gain using a conventional alignment procedure.

FIG. 4 is a flow chart illustrating an alignment method for aligning a media sensing system according to another example of the invention.

The same numbers are used throughout the figures to designate the same or similar parts.

### DESCRIPTION

Examples of a new media sensing system and alignment procedure are shown in the figures and described below. The new sensing system and the new alignment procedure were developed to help simplify the alignment process for crash sensors in large format inkjet printers. The new system and the new procedure, however, are not limited to crash sensors or to use in inkjet printers. Thus, nothing in this Description should be construed to limit the scope of the invention, which is defined in the claims that follow the Description.

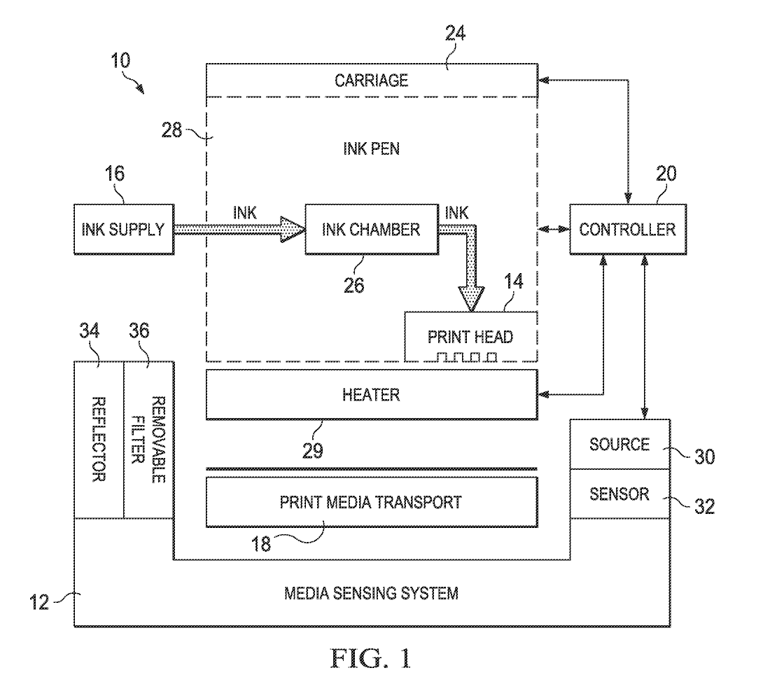

FIG. 1 is a block diagram illustrating an inkjet printer 10 that includes a new media sensing system 12 according to one example of the invention. Referring to FIG. 1, inkjet printer 10 includes a printhead 14, an ink supply 16, a print media transport mechanism 18 and a controller 20. Printhead 14 in FIG. 1 represents generally one or more printheads and the associated mechanical and electrical components for dispensing drops of ink on to a sheet or a continuous web of paper or other print media 22. Printhead 14 may include one or more stationary printheads that span the width of print media 22. Alternatively, printhead 14 may include one or more printheads scanned back and forth on a carriage 24 across the width of media 22. Printhead 14 may include, for example, thermal ink dispensing elements or piezoelectric ink dispensing elements. Other printhead configurations and ink dispensing elements are possible.

Media transport 18 advances print media 22 past printhead 14. For a stationary printhead 14, media transport 18 may advance media 22 continuously past printhead 12. For a scanning printhead 14, media transport 18 may advance media 22 incrementally past printhead 14, stopping as each swath is printed and then advancing media 22 for printing the next swath. An ink chamber 26 is usually housed together with printhead 14 in an ink pen 28, as indicated by the dashed line in FIG. 1. Printer 10 typically will include several ink pens 28 mounted on carriage 24, for example one pen 28 for each of several colors of ink. A heater 29 positioned downstream along the media path from ink pen(s) 28 helps speed drying ink applied to media 22.

Media sensing system 12 includes a light source 30 and a light sensor 32 positioned on one side of the print media path and a light reflector 34 positioned on the other side of the media path opposite source 30 and sensor 32. Light source 30 projects a beam of light across the media path to reflector 34 which reflects light back to light sensor 32. Media sensing system 12 also includes a removable light filter 36 between light source 30 and light sensor 32. Although filter 36 may be positioned adjacent to reflector 34, as suggested in the block diagram of FIG. 1, other locations between source 30 and sensor 32 are possible. As described below, removable filter 36 is used to align light source 30, light sensor 32 and reflector 34. Aligning source 30, sensor 32 and reflector 34 is also sometimes referred to as calibrating media sensing system 12.

Controller 20 in FIG. 1 represents generally the programming, processor(s) and associated memories, and the electronic circuitry and components needed to control the operative elements of printer 10. In a printing operation, controller 20 receives print data and, if necessary, processes that data into printer control information and image data. Controller 20 controls the movement of carriage 24 and media transport 18. Controller 20 is electrically connected to printhead 12 to energize the ink dispensing elements to dispense ink drops on to media 22. By coordinating the relative position of printhead 12 and media 22 with the location of dispensed ink drops, controller 20 produces the desired image on media 22 according to the print data. Controller 20 is operatively connected to heater 29 to control heater functions. Controller 20 is also operatively connected to media sensing system 12 to shut down heater 29 in the event media 22 is detected too close to heater 29.

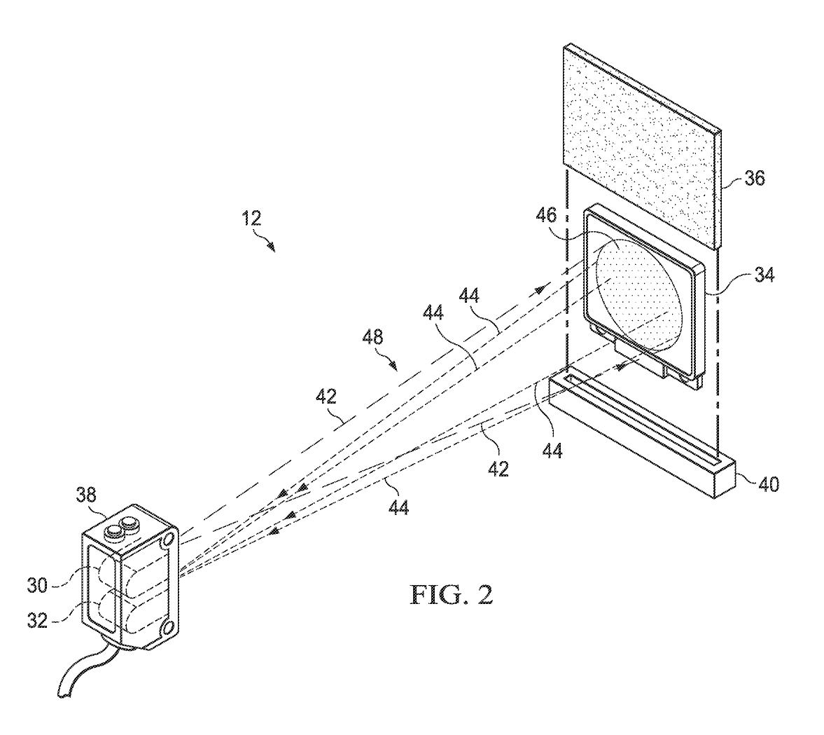

FIG. 2 is a perspective and partially exploded view illustrating one example implementation of a media sensing system 12 such as that shown in FIG. 1. Referring to FIG. 2, system 12 includes a light source 30 and a light sensor 32 which, in the example shown, are housed together in a single unit 38. Source/sensor unit 38 is positioned on one side of the media path opposite a light reflector 34 on the other side of the media path. A portable light filter 36 is held in a holder 40 just in front of reflector 34. Portable filter 36 is installed into holder 40 to calibrate system 12 and removed from holder 40 during normal printer operations. The light from source 30 in FIG. 2 is depicted generally by direction arrows 42 for light passing out toward reflector 34, by direction arrows 44 for light reflected back toward to sensor 32, and by stippling 46 for light hitting reflector 34. FIG. 2 shows system 12 properly calibrated—the light from source 30 reaches reflector 32 at the proper angle and displacement so that sufficient light is reflected back to sensor 32 to signal that sensor 32 is not blocked by the print media. If the print media moves up to block the light so that the amount of light reaching sensor 32 drops below a “trigger” threshold, then sensor 32 will signal the abnormality and controller 20 in FIG. 1 may, for example, turn off heater 29. Although only one filter 36 and one holder 40 are shown, more than one filter and more than one holder could be used, at the same or different locations from that shown in FIG. 2.

If source/sensor unit 38 in media sensing system 12 is not correctly aligned with reflector 34, less than the desired amount of light will reach sensor 32. If the amount of light reaching sensor 32 due to misalignment falls below the trigger threshold, then sensor 32 will signal an abnormality when there is none—a false alarm. One positional error that causes misalignment in system 12 is an angular error in which source/sensor unit 38 and reflector 34 are twisted with respect to one another. Another positional error that causes misalignment is a displacement error in which the source/sensor unit 38 and the reflector 34 are laterally or vertically displaced with respect to one another.

Media sensing system 12 operating in a printer 10 (FIG. 1) is exposed to contaminants, such as dust, dirt, ink aerosol, and media fibers. Contaminants tend to collect on the exposed surfaces of light source 30, light sensor 32 and reflector 34. Thus, over time, as contaminants build up in system 12, the amount of light reaching sensor 32 is reduced. If the amount of light is reduced below the trigger threshold, then sensor 32 will signal a false alarm. One way to compensate for the degrading effect of contaminants on the performance of system components is to overpower light source 30 with respect to the amount of light needed to trigger sensor 32. In other words, light source 32 puts out more power than is needed to trigger sensor 32 when there is no system degradation. The excess power is selected based on the amount of degradation that is expected over a predetermined life cycle, such as the life of the printing system or over the useful life of the media sensing system components.

Suppose sensor 32 triggers when receiving an amount of light equal to a gain of 1. Then, if operating in an ideal, clean environment, the power output of light source 30 would only need to be at a gain of 1. The actual gain is higher to compensate for system degradation. For example, to compensate for 50% degradation over the appropriate life cycle, the power output of light source 30 would need to be at a gain of at least 2 to maintain proper system function throughout the life cycle. The gain may be higher or lower depending on the expected environmental and operating conditions of the printer.

The effect of excess gain in the power output of light source 30 must be taken into account when calibrating system 12. When the system components are aligned during manufacture or set-up, the system components are clean. Consequently, there is no degradation in the amount of light received by sensor 32. If no compensation is made for excess gain, sensor 30 may still receive light above the trigger threshold even though system components are misaligned, resulting in a premature failure of sensing system 12. As the contaminants build up, the light receive by sensor 32 will be reduced below the trigger threshold sooner than expected.

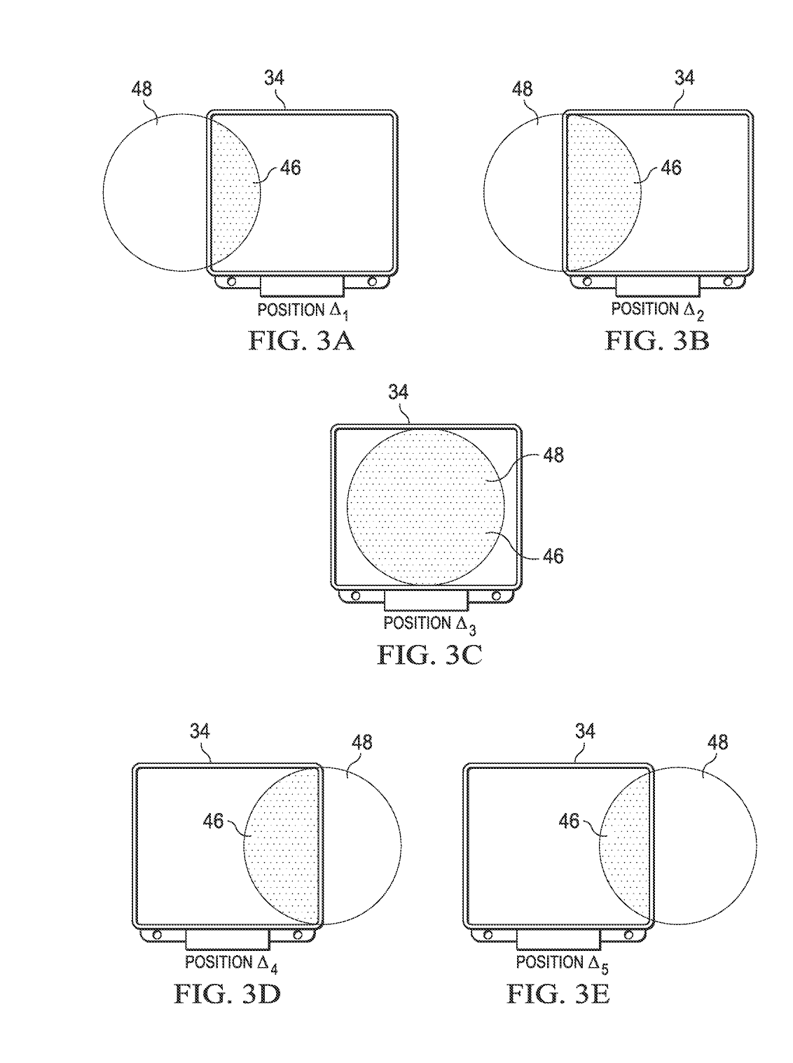

The difficulty compensating for excess gain in a conventional alignment procedure is illustrated in FIGS. 3A-3E. Each of FIGS. 3A-3E shows a different position of a light beam 48 hitting a reflector 34. Stippling 46 indicates where light beam 48 hits reflector 34. In this example, the expected degradation is 50% and, thus, the light source puts out power at a gain 2 to achieve a trigger threshold of gain 1 throughout the appropriate life cycle. In FIGS. 3A and 3E, less than 50% of the beam hits reflector 34 and the light reflected to the sensor will be less than the trigger threshold (gain 1). In FIGS. 3B and 3D, 50% of beam 48 hits reflector 34 and the light reflected to the sensor will be equal to the trigger threshold. If the system were to be calibrated to the position of FIG. 3B or the position of FIG. 3D, the system would work properly but only until contamination began to degrade system performance even slightly. In FIG. 3C, 100% of beam 48 hits reflector 34 and the light reflected to the sensor will be double the trigger threshold. FIG. 3C represents the desired alignment of the system components.

The operator, however, has no way of knowing which of the sensor “on” positions shown in FIG. 3B, 3C or 3D she is experiencing. She knows only that the sensor is receiving light at or above the trigger threshold—light beam 48 could be aligned at any of the positions shown in FIG. 3B, 3C, or 3D or at any position in between. Consequently, in a conventional alignment method, the operator moves the light sensor (or the light source) through a series of alignment angles or other positions with respect to the reflector, such as position angles Δ₁, Δ₂, Δ₃, Δ₄, and Δ₅ in FIGS. 3A-3E, respectively. The state of the sensor (on or off) is checked at each position to determine whether or not the light received is above the trigger threshold. The desired position, shown in FIG. 3C, may be estimated as the mid-point between the position at which the sensor first turns on (Δ₂, in FIG. 3B) and the position at which the sensor first turns off (Δ₄, in FIG. 3D). The accuracy of this estimate depends on the accuracy with which the turn-on and turn-off positions are determined. Smaller position changes will provide a more accurate estimate, but make the alignment procedure more time consuming. The accuracy of the conventional alignment method is also highly dependent on the operator accurately measuring position angles and computing mid-points.

Implementations of the new sensing system, such as that shown in FIG. 2, enable a new alignment method that helps overcome disadvantages of the conventional alignment method. Referring again to FIG. 2, filter 36 is placed into holder 40 when system alignment is desired, for example during assembly or maintenance of the printer. Filter 36 is removed from holder 40 after alignment is completed to allow for normal printer operations. The system components shown in FIG. 2 could also be used outside the printer to calibrate a source/sensor unit 38, for example during a bench alignment performed before unit 38 is assembled into a printer.

Filter 36 is configured to compensate for the excess gain of light source 30, for example to simulate maximum allowable system degradation. Using the example described above, if the power output of light source 30 is twice that needed to trigger sensor 32 under new or like-new conditions (a gain of 2), then filter 36 may be configured to reduce the light received by sensor 32 to one-half the unfiltered level to simulate 50% degradation over the life of system 12. If filter 36 is configured to reduce the light to a level equal to the trigger threshold of sensor 32 (or to a level within an acceptable tolerance above the trigger threshold), then there is only one alignment position that will trigger sensor 32. That is to say, proper alignment may be achieved by adjusting the relative positioning of light source 30, light sensor 32, and reflector 34 until sensor 32 is triggered. While it is expected that filter 36 will be configured to fully compensate for the excess gain of light source 30, other configurations are possible.

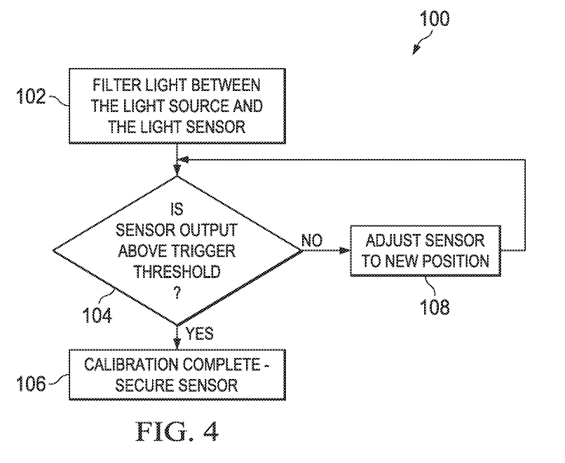

One example of a new alignment method 100 is illustrated in FIG. 4. Method 100 will be described with reference to the components of media sensing system 12 in FIG. 2 with a filter 36 configured to fully compensate for the excess gain of light source 30, simulating the maximum allowable system degradation. Also, sensor 32 is deemed to be the adjustable component in system 12 for method 100. However, any one or more of the light source 30, light sensor 32 and reflector 34 could be adjustable components in system 12.

Referring to FIG. 4, alignment method 100 begins at step 102 by filtering light from source 30 before it reaches sensor 32. For the system shown in FIG. 2, filtering step 102 is performed by installing portable filter 36 into holder 40 between source/sensor unit 38 and reflector 34. In this example implementation for system 12, filter 36 filters light projected from source 30 to reflector 34 and light reflected back from reflector 34 to sensor 32. Other configurations are possible. For example, if the light source and the light sensor are positioned opposite one another, then the light will pass through the filter only once before reaching the light sensor.

The output of sensor 32 is checked at step 104. If the output of sensor 32 indicates the light received is above the trigger threshold, then system 12 is properly aligned and sensor 32 is secured into this correct position at step 106 and filter 36 may be removed from holder 40. If the output of sensor 32 indicates the light received is below the trigger threshold, then sensor 32 is adjusted to a new position at step 108, and the steps of checking 104 and adjusting 108 are repeated until the output of sensor 32 indicates the light received is above the trigger threshold. The alignment of sensor 32 may be checked easily at any time by reinstalling filter 36 into holder 40 and checking the output of sensor 32. Different filter configurations may be used throughout the life of the printer to simulate expected system degradation to check the alignment of sensor 32 and to re-calibrate system 12 if sensor 32 is determined to be out of alignment. Alignment method 100 simplifies the alignment process by eliminating the need to identify multiple “trigger” positions and compute the correct alignment position.

As noted at the beginning of this Description, the examples shown in the figures and described above illustrate but do not limit the invention. Other forms, details, and embodiments may be made and implemented. Therefore, the foregoing description should not be construed to limit the scope of the invention, which is defined in the following claims.

What is claimed is:

1. A media sensing system for a printer, comprising:
a light source;
a light sensor for receiving light from the light source; and
a portable filter removably supported between the light source and the light sensor, the filter configured to reduce the amount of light received by the light sensor from the light source.

2. The system of claim 1, further comprising a light reflector located between the light source and the light sensor for reflecting light from the light source to the light sensor.

3. The system of claim 2, wherein the portable filter is removably supported between the light source and the light reflector.

4. The system of claim 2, wherein the filter is configured to simulate a degradation over time of the performance of the light source, the light sensor, and/or the reflector.

5. The system of claim 2, wherein the filter is configured to reduce the light received by the light sensor to near a predetermined threshold but not below the threshold.

6. The system of claim 2, wherein the filter is configured to reduce the light received by the light sensor to a level equivalent to a light source gain of 1.

7. A media sensing system for a printer, comprising:
a light source located on a first side of a media path;
a light sensor for receiving light from the light source, the light sensor located on the first side of the media path near the light source;
a light reflector located on a second side of the media path opposite the first side for reflecting light from the light source to the light sensor;
a filter support located between the light source and the light sensor; and
a portable filter removably supportable in the support such that the filter may be installed into and removed from the support, the filter configured to reduce the amount of light received by the light sensor from the light source.

8. The system of claim 7, wherein the filter support is located on the second side of the media path near the light reflector.

9. The system of claim 7, wherein the filter is configured to simulate a degradation over time of the performance of the light source, the light sensor, and/or the reflector.

10. The system of claim 7, wherein the filter is configured to reduce the light received by the light sensor to near a predetermined threshold but not below the threshold.

11. The system of claim 7, wherein the filter is configured to reduce the light received by the light sensor to a level equivalent to a light source gain of 1.

12. A method for aligning a media sensing system, comprising:
a light source emitting light toward a light sensor;
filtering the emitted light before it reaches the light sensor;
the sensor sensing filtered light; and
if a desired amount of filtered light is not sensed by the sensor, then adjusting the position of the light source and/or the light sensor until the desired amount of filtered light is sensed by the sensor.

13. The method of claim 12, wherein the light source emitting light toward the sensor comprises the light source emitting light toward a reflector and the reflector reflecting light toward the light sensor.

14. The method of claim 13, wherein filtering the emitted light before it reaches the light sensor comprises filtering the emitted light before it reaches the reflector.

15. The method of claim 13, wherein filtering the emitted light before it reaches the light sensor comprises filtering reflected light.

16. The method of claim 13, wherein filtering the emitted light before it reaches the light sensor comprises filtering the emitted light before it reaches the reflector and filtering the reflected light.
